(19) United States
(12) Patent Application Publication
(10) Pub. No.: US 2008/0102372 A1
(43) Pub. Date: May 1, 2008

(54) CATHODE ACTIVE MATERIAL FOR LITHIUM ION RECHARGEABLE BATTERY AND MANUFACTURING METHOD THEREOF

(75) Inventor: Yoshihide OHISHI, Tokyo (JP)

Correspondence Address: GREENBLUM & BERNSTEIN, P.L.C., 1950 ROLAND CLARKE PLACE, RESTON, VA, 20191, US

(73) Assignee: NIPPON CHEMICAL INDUSTRIAL CO., LTD, Tokyo (JP)

(21) Appl. No.: 11/877,070

(22) Filed: Oct. 23, 2007

(30) Foreign Application Priority Data
Oct. 25, 2006 (JP) 2006-290371

(51) Int. Cl. H01M 4/58

(52) U.S. Cl. 429/231.95

(57) ABSTRACT

A method for manufacturing a cathode active material for a lithium ion rechargeable battery, including: impact grinding a bulk sintered lithium transition metal composite oxide using an impact fine grinding mill to obtain a lithium transition metal composite oxide powder having an average particle size of D μm (D being a number from 5 to 25); classifying the lithium transition metal composite oxide powder using an air classifier by setting a classification point for removing a small particle component to less than or equal to 0.6×D μm and a classification point for removing a large particle component to greater than or equal to 1.2×D μm; and removing the small and large particle components to obtain cathode active material including a lithium transition metal composite oxide powder having an average particle size of from 5 to 25 μm.

### CROSS-REFERENCE TO RELATED APPLICATIONS

The present application claims priority under 35 U.S.C. §119 of Japanese Application No. 2006-290371, filed on Oct. 25, 2006, the disclosure of which is expressly incorporated by reference herein in its entirety.

### BACKGROUND OF THE INVENTION

1. Field of the Invention

The present invention relates to cathode active material for a lithium ion rechargeable battery and a manufacturing method thereof.

2. Description of Related Art

Along with the recent rapid progress in the field of domestic appliances toward portable and cordless, lithium ion rechargeable batteries have come into practical use as power sources for compact electronic devices such as laptop computers, portable telephones and video cameras. As a cathode active material for a lithium ion rechargeable battery, a lithium transition metal composite oxide, or a lithium transition metal composite oxide with part of the transition metal being substituted by other metallic elements, such as a cobalt-based material (e.g., LiCoO₂ and LiCo₁₋ₓMgₓO₂), a nickel-based material (e.g., LiNiO₂ and LiNi_{0.8}CO_{0.1}Mn_{0.1}O₂) and a manganese-based material (e.g., LiMn₂O₄), have been proposed.

The cathode active material for a lithium ion rechargeable battery is normally mixed with a conductive substance, a binder and other additives to make a paint, which is then applied to a current collector to form a cathode sheet. Then, a battery is formed by combining the cathode sheet with an anode sheet, a separator, and the like. However, foreign particles may get mixed in with the lithium transition metal composite oxide or the like, which is the cathode active material, due to some reasons during a manufacturing process of the lithium transition metal oxide. It is certainly not desirable to use, without any further processing, the lithium transition metal composite oxide or the like as the cathode active material that contains foreign particles. The foreign particles are presumably metallic, ceramic, or the like. During charging and discharging processes, metallic particles contained in the cathode active material may be dissolved in an electrolyte solution and precipitate on the anode, thereby causing such problems as reducing safety and performance of the battery and breaking through the separator when the cathode sheet is winded.

Several methods have been proposed for preventing performance degradation due to metallic particles contained in the cathode active material for a lithium ion battery (Related Arts 1-8). The methods for preventing performance degradation due to metallic particles can be broadly divided as follows: methods for preventing occurrence of metallic particles by improving a grinding process and the like (Related Arts 1-3); methods for filtering a cathode active material for a lithium ion battery that contains metallic particles (Related Arts 4-5); and methods for removing metallic particles from a cathode active material for a lithium ion battery that contains metallic particles (Related Arts 5-8).

Related Art 1 proposes a method for grinding by using a pin mill that has undergone a hardening treatment by using a cemented carbide. However, this method has a problem that the content of metallic particles is still high, even though it can reduce Fe content to several tens ppm.

In Related Art 2, a crushing process is performed by using a pin mill in order to crush ternary particles, the ternary particles being formed by lightly sintering secondary particles. However, Related Art 2 does not mention about a grinding process for crushing the secondary particles into primary particles; neither does it describe about the occurrence of metallic particles during a grinding process using a pin mill.

Related Art 3 proposes a method that results in a metallic Fe content of less than 5 ppm in an active material for a lithium rechargeable battery through a grinding process by using a ball mill that makes use of a polypropylene vessel and alumina balls. However, particle size distribution of the active material for a lithium rechargeable battery obtained by using this method is broad. Furthermore, since this method requires to prolong grinding time, it is industrially unsuitable.

Related Art 4 proposes a method for detecting foreign particles by using a device that detects magnetic turbulence by using a magnetic impedance effect. Although this method can filter an electrode material containing foreign particles, it cannot remove foreign particles from the electrode material.

Related Art 5 describes a method that turns a cathode material into a slurry, and then uses a magnet to separate metallic particles in the slurry. However, since this method requires a large amount of solvent, it is industrially unsuitable.

Methods for magnetic metallic particle removal without using a solvent have been proposed in Related Arts 6-8. However, the method proposed in Related Art 6 has a problem that it requires processing under a high temperature between 200° C. and 600° C., thereby changing properties of a cathode active material being processed. In Related Art 7, attraction stronger than a magnetic flux density level, at which a lithium transition metal composite oxide is attracted, cannot be used, thereby preventing rapid and sufficient removal of fine foreign particles. In addition, although the method proposed in Related Art 8 is able to remove high density particles having particle size greater than or equal to 15 μm by separating them to the side of coarse particles, it cannot separate high density particles from a cathode active material in the case where high density particles having particle size less than or equal to 15 μm are mixed in and in the case where a cathode active material having particle size greater than or equal to 15 μm is being processed.

[Related Art 1] Japanese Patent Laid Open Publication No. 2000-58054

[Related Art 2] Japanese Patent Laid Open Publication No. 2005-276597

[Related Art 3] Japanese Patent Laid Open Publication No. 2004-6423

[Related Art 4] Japanese Patent Laid Open Publication No. 2005-183142

[Related Art 5] Japanese Patent Laid Open Publication No. 2002-358952

[Related Art 6] Japanese Patent Laid Open Publication No. 2003-34532

[Related Art 7] Japanese Patent Laid Open Publication No. 2003-183029

[Related Art 8] International Patent Publication No. WO 00/079621 Pamphlet

### SUMMARY OF THE INVENTION

The present invention is provided to resolve the above-described problems associated with the conventional technologies. A main purpose of the present invention is to provide a cathode active material for a lithium ion rechargeable battery and a manufacturing method thereof that enable efficient removal of metallic particles of Fe and the like from the cathode active material for a lithium ion rechargeable battery, and enable manufacturing lithium ion rechargeable batteries having superior safety and battery characteristics.

To resolve the above-described problems associated with the conventional technologies, the inventors of the present invention have conducted intensive studies, and found that a lithium transition metal composite oxide powder obtained by impact grinding a bulk sintered lithium transition metal composite oxide using an impact fine grinding mill has a sharper particle size distribution as compared to a powder obtained by a grinding process using a grinding tool such as a ball mill. The inventors further found that, by adjusting an average particle size to a particular range using an impact fine grinding mill and by air classifying the resulting lithium transition metal composite oxide powder using an air classifier, metallic particles are largely classified to small and large particle component sides. The inventors obtained a cathode active material for a lithium ion rechargeable battery having a low metallic particle content by removing metallic particles together with lithium transition metal oxide particles that have been classified to the small and large particle component sides. The inventors found that, in a lithium ion rechargeable battery that makes use of the cathode active material, battery performance degradation due to precipitation of metals on the anode is inhibited. The present invention has been accomplished based on these findings.

An aspect of the present invention is a method for manufacturing a cathode active material for a lithium ion rechargeable battery, the method including: impact grinding a bulk sintered lithium transition metal composite oxide using an impact fine grinding mill to obtain a lithium transition metal composite oxide powder having an average particle size of D μm (D being a number from 5 to 25); classifying the lithium transition metal composite oxide powder using an air classifier by setting a classification point for removing a small particle component to less than or equal to 0.6×D μm and a classification point for removing a large particle component to greater than or equal to 1.2×D μm; and removing the small and large particle components to obtain cathode active material including a lithium transition metal composite oxide powder having an average particle size of from 5 to 25 μm.

It is desirable to classify the lithium transition metal composite oxide powder using an air classifier by setting a classification point for removing a small particle component to from 0.1×D to 0.6×D μm and a classification point for removing a large particle component to from 1.2×D to 5.0×D μm.

It is desirable that the cathode active material including the lithium transition metal composite oxide powder has an average particle size from 7.0 to 23.0 μm.

It is desirable to classify the lithium transition metal composite oxide powder using an air classifier by setting a classification point for removing a small particle component to from 0.5 to 5 μm and a classification point for removing a large particle component to from 20 to 75 μm; and obtain cathode active material including the lithium transition metal composite oxide powder having an average particle size of from 10 to 20 μm.

It is desirable that the lithium transition metal composite oxide powder being classified and having an average particle size of D μm (D being a number from 5 to 25) contains from 35 to 47 weight % of particles having particle size greater than or equal to 0.5×D and less than 1.0×D μm and from 40 to 47 weight % of particles having particle size greater than or equal to 1.0×D and less than 2.0×D μm.

It is desirable that the air classifier is an Elbow-Jet classifier.

It is desirable that the bulk sintered lithium transition metal composite oxide is obtained by sintering a mixture of a lithium compound and a transition metal compound, the mixture having a molar ratio (Li/M) greater than 1 between lithium atoms (Li) in the lithium compound and transition metal atoms (M) in the transition metal compound.

It is desirable that impurity content of the small and large particle components in the classified lithium transition metal composite oxide powder is greater than impurity content of the lithium transition metal composite oxide powder having the small and large particle components removed, the impurity including Fe, Ni and Cr.

Another aspect of the present invention is a cathode active material for a lithium ion rechargeable battery including a lithium transition metal composite oxide powder having an average particle size from 5 to 25 μm, the lithium transition metal composite oxide powder being prepared by: impact grinding a bulk sintered lithium transition metal composite oxide to obtain a lithium transition metal composite oxide powder having such a particle size distribution that the average particle size is D μm (D being a number from 5 to 25); classifying the lithium transition metal composite oxide powder by setting a classification point for removing a small particle component to less than or equal to 0.6×D μm and a classification point for removing a large particle component to greater than or equal to 1.2×D μm; and removing the small and large particle components.

According to the present invention, metallic particles of Fe and the like can be reduced to less than or equal to 5 ppm or optimally less than or equal to 1 ppm, and a cathode active material for a lithium ion rechargeable battery can be easily and efficiently manufactured. Furthermore, in a lithium ion rechargeable battery that makes use of the cathode active material, battery performance degradation due to precipitation of metals on the anode can be inhibited.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates particle size distributions of an impact ground lithium cobalt oxide before and after classification according to a first embodiment of the present invention;

FIG. 2 illustrates particle size distributions of an impact ground lithium cobalt oxide before and after classification according to a second embodiment of the present invention;

FIG. 3 illustrates particle size distributions of an impact ground lithium cobalt oxide before and after classification according to a third embodiment of the present invention; and

FIG. 4 illustrates particle size distributions of an impact ground lithium cobalt oxide before and after classification according to a first comparative example.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The present invention is explained in the following based the preferred embodiments.

The method of the present invention for manufacturing a cathode active material for a lithium ion rechargeable battery includes: impact grinding a bulk sintered lithium transition metal composite oxide using an impact fine grinding mill to obtain a lithium transition metal composite oxide powder having an average particle size of D μm (D being a number from 5 to 25); classifying the lithium transition metal composite oxide powder using an air classifier by setting a classification point for removing a small particle component to less than or equal to 0.6×D μm and a classification point for removing a large particle component to greater than or equal to 1.2×D μm; and removing the small and large particle components to obtain cathode active material including a lithium transition metal composite oxide powder having an average particle size from 5 to 25 μm.

In the present invention, the term “bulk sintered lithium transition metal composite oxide” denotes a sintered and partially bulked object formed by sintering the particles before performing the grinding process in the method for manufacturing a cathode active material for a lithium ion rechargeable battery through a process for sintering a mixture containing a lithium compound and a transition metal compound, a grinding process and a classification process.

Examples of a lithium compound include lithium hydroxide and lithium carbonate. Examples of a transition metal compound include transition metal oxide, hydroxide, oxyhydroxide, carbonate, nitrate, phosphate, and organic acid salt, as well as composite hydroxide, composite carbonate and composite organic acid salt that contain one or more transition metals. Examples of a transition metal include cobalt, nickel, manganese, steel, titanium, vanadium, chromium and copper.

The mixture that contains a lithium compound and a transition metal compound may also contain other components such as an alkali earth metal oxide, a hydroxide, a carbonate, a phosphate, a sulfate and a fluoride.

In the present invention, the bulk sintered lithium transition metal composite oxide is obtained by sintering a mixture of a lithium compound and a transition metal compound. The mixture having a molar ratio (Li/M) greater than 1, optimally in the range of from 1.001 to 1.050, between lithium atoms (Li) in the lithium compound and transition metal atoms (M) in the transition metal compound become primary particles having particle sizes from 5 to 25 μm. The bulk sintered lithium transition metal composite oxide so obtained is desirable because there are almost no particle size changes during a grinding process using an impact fine grinding mill as described hereinbelow.

A sintering condition depends upon a lithium transition metal composite oxide to be obtained. As will be described hereinbelow, in the case of a cobalt-based material, the sintering temperature is from 900 to 1100° C., or optimally from 1000 to 1050° C., in an air atmosphere. In the case of a nickel-based material, the temperature is from 700 to 1000° C., or optimally from 750 to 850° C., in an oxidant atmosphere. In the case of manganese-based material, the temperature is from 700 to 1000° C., or optimally from 750 to 900° C., in an oxidant or inert atmosphere. And in the case of a lithium transition metal composite phosphate, the temperature is from 500 to 1000° C., or optimally from 550 to 800° C., in an inert or reductive atmosphere.

Specific examples of a lithium transition metal composite oxide include a cobalt-based material such as LiCoO₂ and LiCo₁₋ₓMgₓO₂, a nickel-based material such as LiNiO₂ and LiNi_{0.8}Co_{0.1}Mn_{0.1}O₂, a manganese-based material such as LiMn₂O₄, and a substance obtained by substituting a part of such a composite oxide with other elements. In the present invention, the lithium transition metal composite oxide also includes lithium transition metal composite phosphate such as LiFePO₄ and substances obtaining by substituting a part of such composite phosphate with other elements. In the present invention, a cobalt-based material is particularly favored among these lithium transition metal composite oxides because it is widely used.

In the present invention, the metallic particles to be removed are mostly metallic particles that originate from raw material and metallic particles that get mixed in during manufacturing processes of the lithium transition metal composite oxide. The metallic particles are mainly Fe, Cr, Ni and the like which are components of a stainless steel. Sizes and contents of the metallic particles depend on materials of manufacturing equipments, and therefore are different for each batch. In general, Fe component of the metallic particles is from several ppm to several tens of ppm.

In the present invention, a lithium transition metal composite oxide powder having an average particle size within a particular range is first obtained by impact grinding a bulk sintered lithium transition metal composite oxide using an impact fine grinding mill.

The lithium transition metal composite oxide powder obtained by impact grinding a bulk sintered lithium transition metal composite oxide using an impact fine grinding mill has a sharper particle size distribution compared to a powder obtained by a grinding process using a grinding tool such as a ball mill. Further, since the metallic particles that get mixed in during manufacturing processes change shapes by the impact grinding process, the lithium transition metal composite oxide powder has a high content of particles having large differences in shape.

The metallic particles change to rod-like or bow-like shapes by the impact grinding process using an impact fine grinding mill. Metallic particles newly generated during the impact grinding process using an impact fine grinding mill also have rod-like or bow-like shapes. Thus, the percentage of metallic particles contained in the lithium transition metal composite oxide that have rod-like or bow-like shapes increases, making it easy to generate, during air classification, a difference in resistance to airflow between lithium transition metal composite oxide particles and metallic particles because of the difference in particle shape. Therefore, the metallic particles that get mixed in during manufacturing processes can be efficiently removed. Using this lithium transition metal composite oxide as a cathode active material is particularly desirable in that it enables manufacturing of a battery having a superior cycle characteristic, a high packing density and a high capacity.

The present invention makes use of the impact fine grinding mill, and prepares a lithium transition metal composite oxide powder having an average particle size D of from 5 to 25 μm, or optimally from 7 to 23 μm, or even more optimally from 10 to 20 μm, by an impact grinding process using the impact fine grinding mill. The reason for keeping the average particle size in this range is that an average particle size less than 5 μm increases the amount of lithium transition metal composite oxide to be removed as a small particle component, thereby reducing the productivity. Also, an average particle size greater than 25 μm increases the ratio of large size particles and the amount of lithium transition metal composite oxide to be removed as a large particle component.

In the present invention, a process for fragmenting the bulk sintered lithium transition metal composite oxide may be performed before the impact grinding process.

Further, for the lithium transition metal composite oxide powder used in the classification process, it is desirable that the content of particles having particle size ratios from 0.5×D μm to 1.0×D μm with respect to the average particle size D is from 35 to 47 weight %, or optimally from 38 to 45 weight %. The reason for this is that a content of less than 35 weight % of particles having particle size ratios greater than or equal to 0.5×D μm and less than 1.0×D μm increases the amount of the small particle component, and a content greater than 47 weight % reduces packing density, thereby reducing yield of a target product. On the other hand, it is desirable that the content of particles having particle size ratios greater than or equal to 1.0×D μm and less than or equal to 2.0×D μm with respect to the average particle size D is from 40 to 47 weight %, or optimally from 43 to 45 weight %. The reason for this is that a content of less than 40 weight % of particles having particle size ratios less than or equal to 2.0×D μm increases the amount of the large particle component, and a content greater than or equal to 47 weight % reduces packing density, thereby reducing yield of a target product. The particle size ratio with respect to the average particle size is obtained as “particle size of a target particle”/“the average particle size.”

There is no particular restriction with respect to the type of the impact fine grinding mill as far as it is an apparatus that breaks solid materials into shatters with great strength by applying a strong impact to the solid materials through a rotating body that rotates with high speed about a horizontal or vertical axis, and having the solid materials collide with a fixed or another rotating body. Examples of the impact fine grinding mill include a pin mill, an ACM pulverizer, an impact mill, and a Pallmann mill. In particular, a pin mill capable of impact grinding using a high speed rotating body, and an ACM pulverizer capable of grinding by making use of both impact and shear actions, are favorably used.

The revolution speed of the rotating body of a such impact fine grinding mill can be varied according to the type of the grinding mill, hardness of the lithium transition metal composite oxide to be ground, and desired particle size. In most cases, it is desirable that the revolution speed is greater than or equal to 6500 rpm, or optimally greater than or equal to 8000 rpm, because in this case, metallic particles that have mixed in during a grinding process are removed to a small particle component side. Since the larger the revolution speed, the more metallic particles are removed to the small particle side, a larger revolution speed is desirable.

When an ACM pulverizer is used in an impact grinding process, in addition to an impact grinding action due to a rotating body, there is also a grinding action due to a shear effect. Therefore, it is desirable that the revolution speed of the rotating body is greater than or equal to 4000 rpm, or optimally greater than or equal to 5000 rpm, because in this case, metallic particles are removed to a small particle component side. Since the larger the revolution speed, the more metallic particles are removed to the small particle component side, a larger revolution speed is desirable.

The reason for doing so is as follows. Conventionally, it is difficult to separate metallic particles from a lithium transition metal composite oxide even by performing an air classification process, the metallic particles being generated due to contact between the lithium transition metal composite oxide and a grinding apparatus. The larger the revolution speed for the grinding process, the larger percentage of metallic particles will change shape to rod-like or bow-like during the grinding process. Metallic particles having such shapes can be removed as small particles despite being high density particles, because they receive stronger drag force influence from an air current during an air classification process, as compared to the lithium transition metal composite oxide or metallic particles having spherical shapes or large sizes, the lithium transition metal composite oxide being the target product. On the other hand, metallic particles having spherical shapes or large sizes are removed as large particles, because they have higher density as compared to the targeted lithium transition metal composite oxide.

Next, the lithium transition metal composite oxide powder obtained by performing an impact grinding process is classified using an air classifier. Small and larger lithium transition metal composite oxide particle components contained in the powder are removed. At the same time, metallic particles of Fe and the like contained in the small and larger particle components are removed.

Classification using an air classifier makes use of the fact that a resistance force received by a particle against physical forces such the gravity, an inertia force and a centrifugal force, is different depending on the size and density of the particle. Large particles and high density particles or small particles and low density particles, can be respectively separated and removed.

Examples of air classifiers being used include a gravity classifier that performs classification based on a difference in fall speeds or fall positions of the particles, an inertia classifier that performs classification by making use of the inertia force of the particles; and a centrifugal classifier that performs classification by making use of a balance between a centrifugal force and a drag force. An inertia classifier is favored, in terms of ease of use and effectiveness in metallic particle removal. Examples of inertia classifiers include an impactor classifier, a louver classifier and an Elbow-Jet classifier. An Elbow-Jet classifier is capable of simultaneously removing a small particle component and a large particle component, and at the same time also capable of having a large classification throughput, and therefore is favored.

The purpose of the air classification process of the present invention is to remove small and large particle components contained in a lithium transition metal composite oxide powder so as to obtain particles having particle sizes within a specific range. In order to do so, the air classification process is performed by at least setting a classification point less than or equal to a specific particle size for removing a small particle component and a classification point greater than or equal to a specific particle size for removing a large particle component of the lithium transition metal composite oxide powder according to the specific range of particle sizes.

A small particle component having particle sizes less than or equal to a specific size and a large particle component having particle sizes greater than or equal to a specific size, which are contained in a lithium transition metal composite oxide powder, can be classified at the same time. However, it is also possible to remove the large particle component by a classification process after the small particle component has been removed by a classification process, or to remove the small particle component by a classification process after the large particle component has been removed by a classification process.

The classification points for separating the small and large particle components can be varied according to the setting of the classifier. Since optimal classification points depend on the shape, density, particle sizes, particle size distribution and the like of the lithium transition metal composite oxide, as well as the shape, density, sizes and the like of metallic particles, it is desirable to select classification points suitable for the cathode active material having metallic particles removed.

Although setting the classification point for the small particle component to a larger particle size increases removal rate of metallic particles, it decreases the yield of the cathode active material, because of the increase in the accompanied amount of removed cathode active material. Similarly, although setting the classification point for the large particle component to a smaller particle size increases removal rate of metallic particles, it decreases the yield of the cathode active material. Normally, the large particle component contains less metallic particles compared to the small particle component. Therefore, as compared to the particle size that serves as the classification point for the large particle component, the particle size that serves as the classification point for the small particle component tends to have a larger influence on the effectiveness of metallic particle removal.

The particle size that serves as the classification point for removing the small particle component is determined by considering the effectiveness of metallic particle removal and the yield of the lithium transition metal composite oxide. It is set to be less than or equal to 0.6×D μm, or optimally from 0.1×D to 0.6×D μm, with respect to a lithium transition metal composite oxide having an average particle size of D μm (D being a number from 5 to 25), the lithium transition metal composite oxide being used in a classification process. When the particle size that serves as the classification point for the small particle component is greater than 0.6×D μm, it tends to reduce the yield of the cathode active material, despite that the removal rate of metallic particles remains almost unchanged. It also tends to reduce the rapid charge-discharge performance of a lithium ion rechargeable battery that uses the cathode active material. The particle size that serves as the classification point for the small particle component is from 0.5 to 5 μm, or optimally from 1 to 4 μm.

The particle size that serves as the classification point for removing the large particle component is determined by considering the effectiveness of metallic particle removal and the yield of the lithium transition metal composite oxide. It is set to be greater than or equal to 1.2×D μm, or optimally from 1.2×D to 5.0×D μm, with respect to a lithium transition metal composite oxide having an average particle size of D μm (D being a number from 5 to 25), the lithium transition metal composite oxide being used in a classification process. It is not desirable that the particle size that serves as the classification point for the large particle component is less than 1.2×D μm, because it reduces the yield of the cathode active material. As a preferred embodiment, the particle size that serves as the classification point for the large particle component is from 20 to 75 μm, or optimally from 20 to 60 μm, so as to avoid problems such as that bulky particles may break through the electrode sheets and the separator, in a case where the metallic particle is not sufficiently removed.

### Embodiments

The present invention is further explained in detail in the following by using embodiments. The embodiments are merely for exemplification purposes, and the invention is not limited to these embodiments.

### (Method for Measuring the Content of Metallic Particles)

A rare earth magnet sealed in a polyethylene bag is placed at the bottom of the inner border of a 1 L glass beaker. 50 g of lithium cobaltate and 500 ml of ethanol are added and stirred for 30 minutes.

Next, the rare earth magnet sealed in the polyethylene bag is taken out. Metallic particles attached to the polyethylene bag are boiled and dissolved by using a hydrochloric acid. Fe, Cr and Ni are quantitatively measured by using an ICP.

### (Average Particle Size and Particle Size Distribution)

The average particle size and particle size distribution are measured by using a Microtrac (HRA (X100), manufactured by Nikkiso Inc.).

### First Embodiment

Commercially-available lithium carbonate (having an average particle size of 7 μm) and commercially-available cobalt oxide (Co₃O₄, having an average particle size of 5 μm) were weighed so as to have an atomic ratio Li/Co of 1.040, and fully mixed by using a mortar to prepare a uniform mixture. Next, the mixture was packed in alumina crucible, which was then placed in an electrically heated furnace, and was heated in an air atmosphere. A bulk sintered material was obtained by sintering the mixture for 5 hours at 1000° C.

The obtained bulk sintered material was cooled in the air, and then was crushed by using a Rotoplex (manufactured by Hosokawa Micron Corporation). The crushed material was then impact ground by using a pin mill (manufactured by Pallmann Pulverizers Company Inc., PXL 18, 8000 rpm,) to obtain a lithium cobaltate (LiCoO₂) powder. An analysis of the lithium cobaltate (LiCoO₂) powder was performed, which indicated that the average particle size was 14.4 μm; the BET ratio surface area was 0.24 m²/g; the content of particles having particle size ratios greater than or equal to 0.5 (7.2 μm) and less than 1.0 with respect to the average particle size was 43.7 weight %; and the content of particles having particle size ratios greater than or equal to 1.0 and less than or equal to 2.0 (28.8 μm) with respect to the average particle size was 43.2 weight %. Measurements of contents of metallic particles contained in the lithium cobaltate powder were performed, which indicated that the content of Fe was 7.5 ppm; the content of Ni was 0.82 ppm; and the content of Cr was 2.01 ppm.

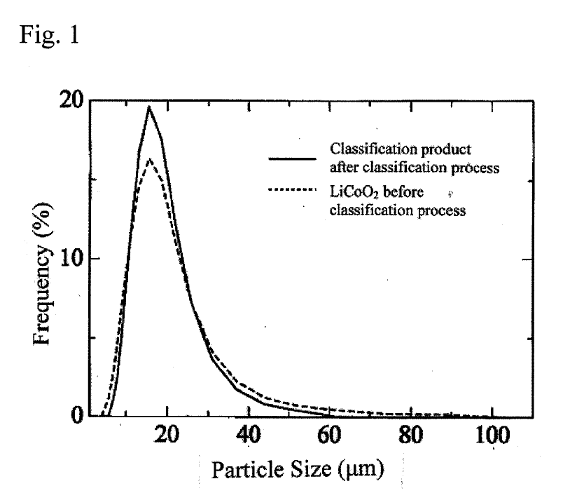

An air classification process was performed on 10 kg of so-obtained lithium cobaltate by using an Elbow Jet (EJ-L-3, manufactured by Matsubo Corporation), in which the particle size that serves as the classification point for the small particle component was 4 μm and the particle size that serves as the classification point for the large particle component was 25 μm. For each of the small particle component (below-classification), the large particle component (above-classification) and an intermediate particle component (classification product) that were obtained by the classification process, a yield and a content of metallic particles were measured, and the results are shown in Table 1. FIG. 1 shows the particle size distribution of the impact ground lithium cobaltate (LiCoO₂) before the classification and the particle size distribution of the classification product after the classification.

TABLE 1

| | After classification | | | |
|---|---|---|---|---|
| | Below- | | Above- | |
| | classification | Classifi- | classification | |
| | (Small particle | cation | (Large particle | Before |
| | component) | Product | component | classification |
| Classification | 4 μm | | 25 μm | |
| point | | | | |
| Classification | ≦4 μm | | ≧25 μm | — |
| particle size | | | | |
| Classification | 6.1 | 92.1 | 1.8 | — |
| percentage | | | | |
| (weight %) | | | | |
| Fe content | 85.3 | 2.3 | 12.0 | 7.5 |
| (ppm) | | | | |
| Ni content | 8.96 | 0.27 | 1.48 | 0.82 |
| (ppm) | | | | |
| Co content | 22.6 | 0.62 | 3.26 | 2.01 |
| (ppm) | | | | |
| Average | | 14.7 | | 14.4 |
| particle | | | | |
| size (μm) | | | | |

### Second Embodiment

Commercially-available lithium carbonate (having an average particle size of 7 μm) and commercially-available cobalt oxide (Co₃O₄, having an average particle size of 5 μm) were weighed so as to have anatomic ratio Li/Co of 1.040, and fully mixed by using a mortar to prepare a uniform mixture. Next, the mixture was packed in alumina crucible, which was then placed in an electrically heated furnace, and was heated in an air atmosphere. A bulk sintered material was obtained by sintering the mixture for 5 hours at 1030° C.

The obtained bulk sintered material was cooled in the air, and then was crushed by using a Rotoplex (manufactured by Hosokawa Micron Corporation). The crushed material was then impact ground by using a pin mill (manufactured by Pallmann Pulverizers Company Inc., PXL 18, 8800 rpm,) to obtain a lithium cobaltate (LiCoO₂) powder. An analysis of the lithium cobaltate (LiCoO₂) powder was performed, which indicated that the average particle size was 16.9 μm; the BET ratio surface area was 0.27 m²/g; the content of particles having particle size ratios greater than or equal to 0.5 (8.4 μm) and less than 1.0 with respect to the average particle size was 41.1 weight %; and the content of particles having particle size ratios greater than or equal to 1.0 and less than or equal to 2.0 (33.8 μm) with respect to the average particle size was 43.5 weight %. Measurements of contents of metallic particles contained in the lithium cobaltate powder were performed, which indicated that the content of Fe was 19.2 ppm; the content of Ni was 2.27 ppm; and the content of Cr was 5.17 ppm.

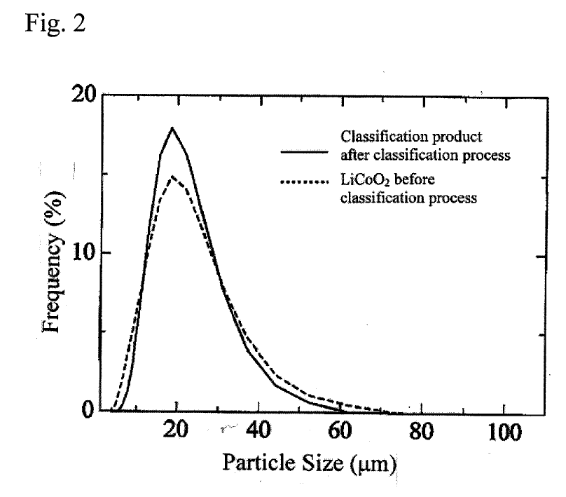

An air classification process was performed on 10 kg of so-obtained lithium cobaltate by using an Elbow Jet (EJ-L-3, manufactured by Matsubo Corporation), in which the particle size that serves as the classification point for the small particle component was 4 μm and the particle size that serves as the classification point for the large particle component was 25 μm. For each of the small particle component (below-classification), the large particle component (above-classification) and an intermediate particle component (classification product) that were obtained by the classification process, a yield and a content of metallic particles were measured, and the results are shown in Table 2. FIG. 2 shows the particle size distribution of the impact ground lithium cobaltate (LiCoO₂) before the classification and the particle size distribution of the classification product after the classification.

TABLE 2

| | After classification | | | |
|---|---|---|---|---|
| | Below- | | Above- | |
| | classification | Classifi- | classification | |
| | (Small particle | cation | (Large particle | Before |
| | component) | Product | component | classification |
| Classification | 4 μm | | 25 μm | |
| point | | | | |
| Classification | ≦4 μm | | ≧25 μm | — |
| particle size | | | | |
| Classification | 4.8 | 91.5 | 3.7 | — |
| percentage | | | | |
| (weight %) | | | | |
| Fe content | 305.2 | 4.6 | 9.1 | 19.2 |
| (ppm) | | | | |
| Ni content | 36.1 | 0.54 | 1.11 | 2.27 |
| (ppm) | | | | |
| Co content | 82.3 | 1.24 | 2.43 | 5.17 |
| (ppm) | | | | |
| Average | | 17.3 | | 16.9 |
| particle | | | | |
| size (μm) | | | | |

### Third Embodiment

Commercially-available lithium carbonate (having an average particle size of 7 μm) and commercially-available cobalt oxide (Co₃O₄, having an average particle size of 5 μm) were weighed so as to have anatomic ratio Li/Co of 1.040, and fully mixed by using a mortar to prepare a uniform mixture. Next, the mixture was packed in alumina crucible, which was then placed in an electrically heated furnace, and was heated in an air atmosphere. A bulk sintered material was obtained by sintering the mixture for 5 hours at 1000° C.

The obtained bulk sintered material was cooled in the air, and then was crushed by using a Rotoplex (manufactured by Hosokawa Micron Corporation). The crushed material was then impact ground by using an ACM Pulverizer (manufactured by Hosokawa Micron Corporation, ACM 10, grinding speed 6000 rpm, classification rotor speed 1300 rpm) to obtain a lithium cobaltate (LiCoO₂) powder. An analysis of the lithium cobaltate (LiCoO₂) powder was performed, which indicated that the average particle size was 15.5 μm; the BET ratio surface area was 0.23 m²/g; the content of particles having particle size ratios greater than or equal to 0.5 (7.7 μm) and less than 1.0 with respect to the average particle size was 38.9 weight %; and the content of particles having particle size ratios greater than or equal to 1.0 and less than or equal to 2.0 (30.9 μm) with respect to the average particle size was 44.5 weight %. Measurements of contents of metallic particles contained in the lithium cobaltate powder were performed, which indicated that the content of Fe was 1.3 ppm; the content of Ni was 0.17 ppm; and the content of Cr was 0.33 ppm.

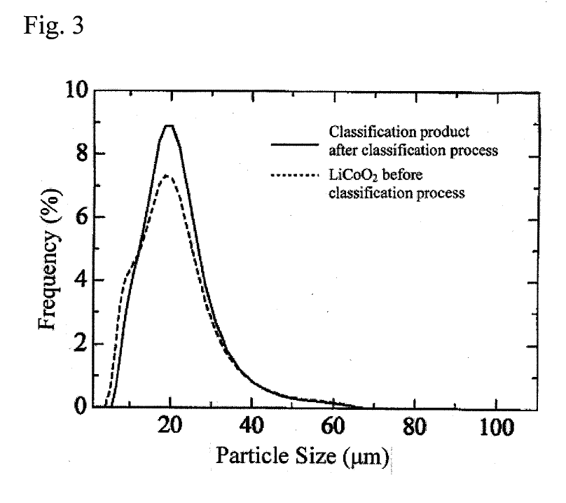

An air classification process was performed on 10 kg of so-obtained lithium cobaltate by using an Elbow Jet (EJ-L-3, manufactured by Matsubo Corporation), in which the particle size that serves as the classification point for the small particle component was 4 μm and the particle size that serves as the classification point for the large particle component was 25 μm. For each of the small particle component (below-classification), the large particle component (above-classification) and an intermediate particle component (classification product) that were obtained by the classification process, a yield and a content of metallic particles were measured, and the results are shown in Table 3. FIG. 3 shows the particle size distribution of the impact ground lithium cobaltate (LiCoO₂) before the classification and the particle size distribution of the classification product after the classification.

TABLE 3

| | After classification | | | |
|---|---|---|---|---|
| | Below- | | Above- | |
| | classification | Classifi- | classification | |
| | (Small particle | cation | (Large particle | Before |
| | component) | Product | component | classification |
| Classification | 4 μm | | 25 μm | |
| point | | | | |
| Classification | ≦4 μm | | ≧25 μm | — |
| particle size | | | | |
| Classification | 6.9 | 92.7 | 0.4 | — |
| percentage | | | | |
| (weight %) | | | | |
| Fe content | 14.98 | 0.19 | 0.23 | 1.30 |
| (ppm) | | | | |
| Ni content | 1.96 | 0.03 | 0.02 | 0.17 |
| (ppm) | | | | |
| Co content | 3.89 | 0.04 | 0.06 | 0.33 |
| (ppm) | | | | |
| Average | | 17.0 | | 15.5 |
| particle | | | | |
| size (μm) | | | | |

As shown in Tables 1-3, the amount of metallic particles in the lithium cobaltate that was classified to the small particle component side by the air classification process increased, indicating that metallic particles are classified to the small particle side. The content of metallic particles in the lithium cobaltate that was classified to the large particle component side also increased. At the same time, the amount of metallic particles in the classification product significantly decreased as compared to that before the air classification process.

Further, as shown in FIGS. 1-3, the classification product obtained by the air classification process has a sharper particle size distribution and a narrower particle size range, as compared to the lithium cobaltate before the air classification process.

### FIRST COMPARATIVE EXAMPLE

Commercially-available lithium carbonate (having an average particle size of 7 μm) and commercially-available cobalt oxide (Co₃O₄, having an average particle size of 5 μm) were weighed so as to have anatomic ratio Li/Co of 1.040, and fully mixed by using a mortar to prepare a uniform mixture. Next, the mixture was packed in alumina crucible, which was then placed in an electrically heated furnace, and was heated in an air atmosphere. A bulk sintered material was obtained by sintering the mixture for 5 hours at 1000° C.

The obtained bulk sintered material was cooled in the air, and then was crushed by using a Rotoplex (manufactured by Hosokawa Micron Corporation). The crushed material was then ground for 24 hour by using a dry ball mill to obtain a lithium cobaltate (LiCoO₂) powder. An analysis of the lithium cobaltate (LiCoO₂) powder was performed, which indicated that the average particle size was 12.9 μm; the BET ratio surface area was 0.33 m²/g; the content of particles having particle size ratios greater than or equal to 0.5 (6.5 μm) and less than 1.0 with respect to the average particle size was 29.2 weight %; and the content of particles having particle size ratios greater than or equal to 1.0 and less than or equal to 2.0 (25.8 μm) with respect to the average particle size was 28.4 weight %. Measurements of contents of metallic particles contained in the lithium cobaltate powder were performed, which indicated that the content of Fe was 0.56 ppm; the content of Ni was 0.18 ppm; and the content of Cr was 0.07 ppm.

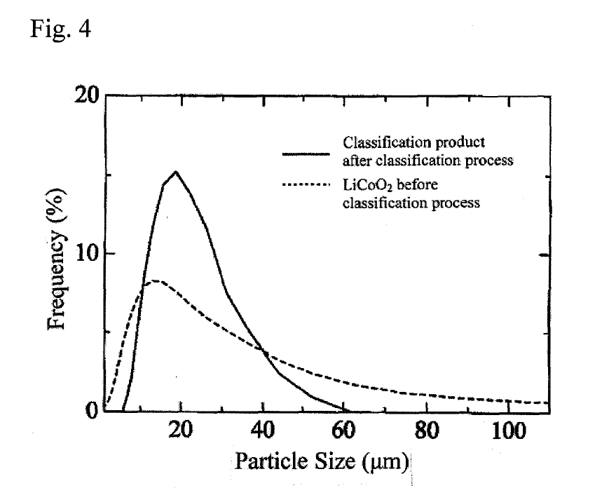

An air classification process was performed on 10 kg of so-obtained lithium cobaltate by using an Elbow Jet (EJ-L-3, manufactured by Matsubo Corporation), in which the particle size that serves as the classification point for the small particle component was 4 μm and the particle size that serves as the classification point for the large particle component was 25 μm. For each of the small particle component (below-classification), the large particle component (above-classification) and an intermediate particle component (classification product) that were obtained by the classification process, a yield and a content of metallic particles were measured, and the results are shown in Table 4. FIG. 4 shows the particle size distribution of the impact ground lithium cobaltate (LiCoO₂) before the classification and the particle size distribution of the classification product after the classification.

TABLE 4

| | After classification | | | |
|---|---|---|---|---|
| | Below- | | Above- | |
| | classification | Classifi- | classification | |
| | (Small particle | cation | (Large particle | Before |
| | component) | Product | component | classification |
| Classification | 4 μm | | 25 μm | |
| point | | | | |
| Classification | ≦4 μm | | ≧25 μm | — |
| particle size | | | | |
| Classification | 16.1 | 78.6 | 5.3 | — |
| percentage | | | | |
| (weight %) | | | | |
| Fe content | 0.03 | 0.54 | 2.54 | 0.56 |
| (ppm) | | | | |
| Ni content | 0.01 | 0.16 | 0.93 | 0.18 |
| (ppm) | | | | |
| Co content | 0.01 | 0.06 | 0.37 | 0.07 |
| (ppm) | | | | |
| Average | | 16.8 | | 12.9 |
| particle | | | | |
| size (μm) | | | | |

As shown in Table 4, the ball mill ground lithium cobaltate has a broad particle size distribution, and the amount that was removed as small and large particle components is large. Further, nearly no effect was obtained in metallic particle removal for the ball mill ground lithium cobaltate, and the yield for the classification product was also low.

### FOURTH-SIXTH EMBODIMENTS AND SECOND-THIRD COMPARATIVE EXAMPLES

### [Battery Performance Test]

### (Cathode Sheet Fabrication)

In fourth, fifth and sixth embodiments, cathode sheets were fabricated by respectively using the lithium cobaltate obtained as the classification products in the first, second and third embodiments. In a second comparative example, a cathode sheet was fabricated by using the lithium cobaltate obtained as the classification product in the first comparative example. In a third comparative example, a cathode sheet was fabricated by using the lithium cobaltate powder (obtained before an air classification process) in the second embodiment.

Fabrication procedures for the cathode sheets were as follows. 91 weight % of lithium cobaltate, 6 weight % of graphite as a conductive material and 3 weight % of polyvinylidene-fluoride as an adhesive were mixed, and were dispersed in N-methyl-2-pyrrolidinone to prepare a slurry. The slurry was applied to an aluminum foil, and was dried. Thereafter, the aluminum foil was pressed by using a roller press apparatus, and was then cut into a predetermined size to obtain a cathode sheet.

### (Anode Sheet Fabrication)

93 weight % of carbon material and 7 weight % of polyvinylidene-fluoride as an adhesive were mixed, and were dispersed in N-methyl-2-pyrrolidinone to prepare a slurry. The slurry was applied to a copper foil, and was dried. Thereafter, the copper foil was pressed by using a roller press apparatus, and was then cut into a predetermined size to obtain an anode sheet.

### (Battery Fabrication)

The cathode sheet and the anode sheet, as well as a separator, were wound to make an electrode group. Leads were attached to the electrode group, which was then placed in a 18650 size cylindrical container (battery can). An electrolyte was enclosed in the battery can to make a cylindrical lithium ion rechargeable battery. A mixed solution of ethylene carbonate and ethyl methyl carbonate having a mixing ratio of 1:1, in which 1 mole of LiPF₆ was dissolved, was used as the electrolyte.

### (Voltage Degradation Test)

The battery was low-current charged for 2 hours until 4.0 V by using an electrical current equivalent to 0.5 C, and then was constant-voltage charged at 4.0 V for 5 hours. After storing the battery at 55° C. for 1 week, the voltage of the battery was measured, and the difference between the voltages before and after the storing was investigated, and the result was shown in Table 5.

### (Cycle Characteristic Test)

The battery was low-current charged for 2 hours until 4.2 V by using an electrical current equivalent to 0.5 C, and then was constant-voltage charged at 4.2 V for 5 hours. After a 10-minute pause, the battery was constant-current discharged at an electrical current equivalent to 0.2 C until 2.7 V. This charge-discharge cycle was repeated 300 times, and a ratio between the service capacity of the 3^{rd} cycle and the service capacity of the 300^{th} cycle (service capacity of the 300^{th} cycle/service capacity of the 3^{rd} cycle) was measured, and the result was shown in Table 5.

TABLE 5

| | | | Service |
|---|---|---|---|
| | | | capacity ratio |
| | | Voltage | (300^{th} cycle service |
| | Lithium cobaltate | degradation | capacity/3^{rd} cycle |
| | utilized | (V) | service capacity) |
| Fourth | First embodiment | 0.02 | 89% |
| embodiment | | | |
| Fifth embodiment | Second | 0.04 | 87% |
| | embodiment | | |
| Sixth embodiment | Third | 0.01 | 91% |
| | embodiment | | |
| Second | First comparative | 0.04 | 83% |
| comparative | example | | |
| example | | | |
| Third | Second | 0.15 | 68% |
| comparative | embodiment, | | |
| example | before | | |
| | classification | | |

As shown in Table 5, the present invention is able to inhibit voltage degradation and improve cycle characteristic by using lithium cobaltate having metallic particles removed, as compared to using cobaltate without having metallic particles removed. Table 5 also shows that, both voltage degradation and service capacity ratio of the second comparative example, in which the ball mill ground lithium cobaltate of the first comparative example was used, are inferior as compared to those of the fourth embodiment, in which the lithium cobaltate of the first embodiment was used, since the removal amount of metallic particles in the second comparative example is smaller than that of the first embodiment.

### INDUSTRIAL APPLICABILITY

The method of the present invention for manufacturing a cathode active material for a lithium ion rechargeable battery allows manufacturing a cathode active material having reduced content of metallic particles, and therefore can be utilized in manufacturing lithium ion rechargeable batteries that can be used as power sources for compact electronic devices such as laptop computers, portable telephones and video cameras.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A method for manufacturing a cathode active material for a lithium ion rechargeable battery, comprising:
impact grinding a bulk sintered lithium transition metal composite oxide using an impact fine grinding mill to obtain a lithium transition metal composite oxide powder having an average particle size of D μm (D being a number from 5 to 25);
classifying the lithium transition metal composite oxide powder using an air classifier by setting a classification point for removing a small particle component to less than or equal to 0.6×D μm and a classification point for removing a large particle component to greater than or equal to 1.2×D μm; and
removing the small and large particle components to obtain cathode active material comprising a lithium transition metal composite oxide powder having an average particle size from 5 to 25 μm.

2. The method for manufacturing a cathode active material for a lithium ion rechargeable battery according to claim 1, comprising:
classifying the lithium transition metal composite oxide powder using the air classifier by setting a classification point for removing the small particle component to from 0.1×D to 0.6×D μm and a classification point for removing the large particle component to from 1.2×D to 5.0×D μm.

3. The method for manufacturing a cathode active material for a lithium ion rechargeable battery according to claim 1, wherein the cathode active material comprises the lithium transition metal composite oxide powder has an average particle size from 7.0 to 23.0 μm.

4. The method for manufacturing a cathode active material for a lithium ion rechargeable battery according to claim 1, comprising:
classifying the lithium transition metal composite oxide powder using the air classifier by setting a classification point for removing the small particle component to from 0.5 to 5 μm and a classification point for removing the large particle component to from 20 to 75 μm; and
obtaining the cathode active material comprising the lithium transition metal composite oxide powder having an average particle size from 10 to 20 μm.

5. The method for manufacturing a cathode active material for a lithium ion rechargeable battery according to claim 1, wherein the lithium transition metal composite oxide powder being classified and having an average particle size of D μm (D being a number from 5 to 25) contains from 35 to 47 weight % of particles having particle size greater than or equal to 0.5×D and less than 1.0×D μm and from 40 to 47 weight % of particles having particle size greater than or equal to 1.0×D and less than or equal to 2.0×D μm.

6. The method for manufacturing a cathode active material for a lithium ion rechargeable battery according to claim 1, wherein the air classifier is an Elbow-Jet classifier.

7. The method for manufacturing a cathode active material for a lithium ion rechargeable battery according to claim 1, wherein the bulk sintered lithium transition metal composite oxide is obtained by sintering a mixture of a lithium compound and a transition metal compound, the mixture having a molar ratio (Li/M) greater than 1 between lithium atoms (Li) in the lithium compound and transition metal atoms (M) in the transition metal compound.

8. The method for manufacturing a cathode active material for a lithium ion rechargeable battery according to claim 1, wherein impurity content of the small and large particle components in the classified lithium transition metal composite oxide powder is greater than impurity content of the lithium transition metal composite oxide powder having the small and large particle components removed, the impurity comprising Fe, Ni and Cr.

9. A cathode active material for a lithium ion rechargeable battery comprising:
a lithium transition metal composite oxide powder having an average particle size of from 5 to 25 μm,
wherein the lithium transition metal composite oxide powder is manufactured by:
impact grinding a bulk sintered lithium transition metal composite oxide to obtain a lithium transition metal composite oxide powder having such a particle size distribution that an average particle size is D μm (D being a number from 5 to 25);
classifying the lithium transition metal composite oxide powder by setting a classification point for removing a small particle component to less than or equal to 0.6×D μm and a classification point for removing a large particle component to greater than or equal to 1.2×D μm; and
removing the small and large particle components.
